(19) United States
(12) Patent Application Publication
(10) Pub. No.: US 2007/0081091 A1
(43) Pub. Date: Apr. 12, 2007

(54) Image pickup device of multiple lens camera system for generating panoramic image

(76) Inventors: Patrick Pan, Taipei (TW); Tatsumi Mitsushita, Fukuoka (JP); Christine Lin, Taipei (TW); Benjamin Kuo, Taipei (TW)

Correspondence Address: FROMMER LAWRENCE & HAUG LLP, 745 FIFTH AVENUE, NEW YORK, NY, 10151, US

(21) Appl. No.: 11/543,482

(22) Filed: Oct. 5, 2006

(30) Foreign Application Priority Data
Oct. 7, 2005 (TW) 94135314

(51) Int. Cl. G02B 13/16

(52) U.S. Cl. 348/335

(57) ABSTRACT

The present invention aims to simplify stitching algorithm which generates horizontal panoramic image. The image pickup device of the present invention comprises a plurality of lenses and positioning means. Said positioning means positions each lens so that the FOV (Field Of View) intersection points of all lenses are aligned in vertical direction. Accordingly, the horizontal parallax does not exist in the image picked up by the camera system and the stitching point remains the same for the objects at different distances.

### FIELD OF THE INVENTION

The present invention relates generally to an image pickup device. More specifically, the present invention relates to an image pickup device of multiple lens camera system for generating panoramic image. The image pickup device can position a plurality of lenses in a multiple camera system so that a simple stitching algorithm is implemented in an ASIC (Application Specific Integrated Circuit) solution.

### DESCRIPTION OF THE PRIOR ARTS

The generation of a panoramic image usually requires taking pictures concurrently by a plurality of cameras and then composing an image by an image processor. On the other hand, a static panoramic image may be formed by using a single camera combined with a panning motor to shoot multiple times and then stitching the images captured each time. For example, Japan Patent No. 11-008845 and No. 11-018003 involve panning motors to capture wide angle images. However, the panning motor increases the cost and size of the camera system. Accordingly, it is desired to generate a panoramic image by a simpler mechanism and a simpler stitching algorithm.

### SUMMARY OF THE INVENTION

The image pickup device of the invention aligns the FOV (Field Of View) intersection points of all lenses to provide a system with fixed stitching points of the captured image so that simple stitching algorithm can be implemented in a low-cost ASIC solution to generate panoramic video.

To achieve the above purpose, the present invention provides an image pickup device of multiple lens camera system, comprising: N lenses, wherein the horizontal field of view for each lens is HFOVᵢ (i=1, 2, . . . , N); positioning means, wherein said positioning means positions each lens on top of the other by rotation of ᵢdegrees (0<ᵢ<HFOVᵢ, i=1, 2, . . . , N−1) in horizontal direction, and said positioning means positions each lens so that the FOV intersection points of all lenses are aligned in vertical direction.

According to an aspect of the present invention, the above-mentioned positioning means tilts each lens with an angle of φᵢ degrees (0<φᵢ<VFOVᵢ, i=1, 2, . . . , N) in vertical direction.

According to another aspect of the present invention, the above-mentioned ₁=₂=₃= . . . =_{N-}1.

According to yet another aspect of the present invention, the total field of view obtained by the above-mentioned N lenses is equal to

$${\sum }_{i = 1}^{N} {HFOV}_{i} - {\sum }_{i = 1}^{N} ( {HFOV}_{i + 1} - {}_{i} ) .$$

### BRIEF DESCRIPTION OF THE DRAWINGS

FIG. 1 is an illustrative diagram of the N lenses of an image pickup device according to the present invention.

FIG. 2 is an illustrative diagram of lens rotation and HFOV (horizontal field of view).

FIG. 3 is a diagram showing the FOV intersection point of a single lens.

FIG. 4 is a diagram showing the horizontal parallax caused by the misalignment of FOV intersection points.

FIG. 5(a) and FIG. 5(b) are diagrams showing overlapping portions of the images of near objects and far objects, respectively, in the case of misalignment.

FIG. 6 is a diagram showing the case in which the FOV intersection points are aligned.

FIG. 7 is a diagram showing the image shift without tilting the camera in vertical direction.

FIG. 8 is a diagram showing the case in which the images are aligned by tilting the camera in vertical direction.

FIG. 9 shows a block diagram of the multiple lens camera system according to the present invention.

### DETAILED DESCRIPTION OF THE INVENTION

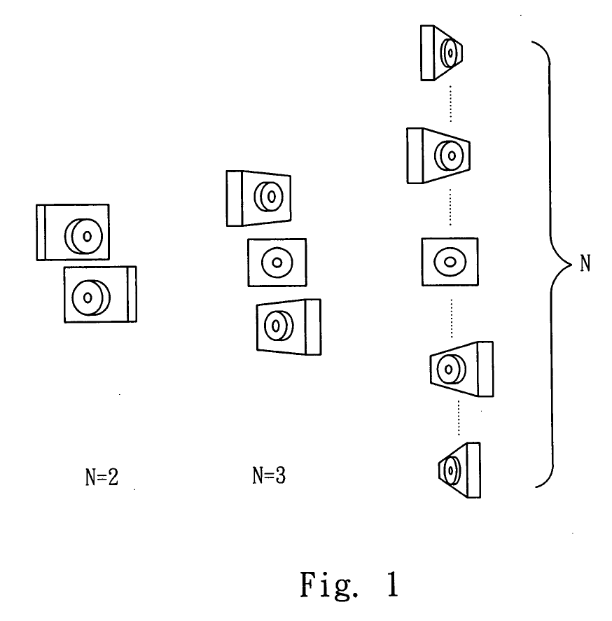

FIG. 1 shows an image pickup device according to the present invention by the examples of 2, 3 and N lenses. This lens arrangement is achieved by positioning means according to the present invention. This positioning means can be a part of a video phone system which creates wide angle images beyond the angle limitation of a single lens. This multiple lens camera system together with a simple ASIC where a simple stitching algorithm is implemented are adapted to provide a low-cost, small-size and wide-angle camera system.

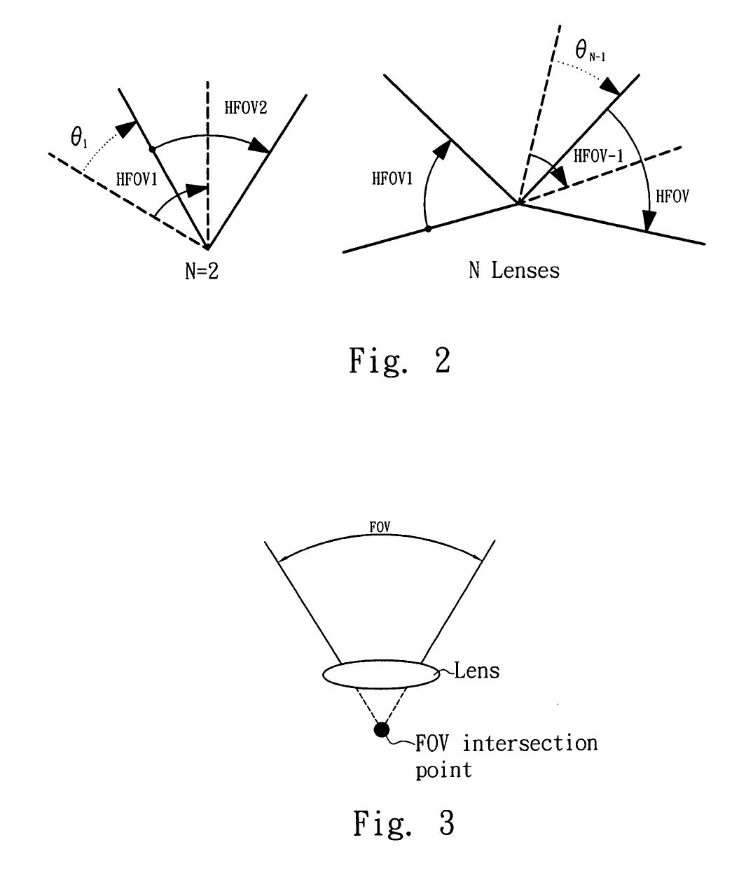

The principle of the present invention is described with reference to FIGS. 2-8 as follows.

The image pickup device according to the present invention comprises N lenses and positioning means. Said positioning means positions each lens on top of the other by rotation of ᵢdegrees (0<ᵢ<HFOVᵢ, i=1, 2, . . . , N−1) in horizontal direction.

FIG. 2 is an illustrative diagram of lens rotation and HFOV (horizontal field of view). Providing N lenses with horizontal view angle of HFOVᵢ for each lens (i=1, 2, 3, . . . , N) and lens rotation angle of θᵢ (i=1, 2, . . . , N−1) in the camera system, the total HFOVt of the system is equal to

$${\sum }_{i = 1}^{N} {HFOV}_{i} - {\sum }_{i = 1}^{N} ( {HFOV}_{i + 1} - {θ}_{i} ) .$$

In case the HFOVᵢ of each lens is equal to HFOV and all rotation angles θᵢ are equal to θ, the total HFOVt of the system will be equal to HFOV*N−(HFOV−θ)*(N−1). For example, N=2, HFOV1=HFOV2=60, and θ₁=30° result in a total HFOVt=90°; and N=11 (11 lenses in total), HFOVᵢ=60° (i=1, 2, 3, . . . 11) and θᵢ=30° (i=1, 2, 3, . . . 10) result in a total HFOVt=360°.

The importance of the invention is to capture images for a simple stitching algorithm which can be implemented in a low-cost ASIC for video stitching. The alignment of the FOV intersection point of each lens provides constant stitching point for the objects at different distance and the rotation angle between each lens is fixed for the camera system. Hence the stitching point can be calculated during camera calibration. It is not necessary for the ASIC to calculate the stitching point dynamically at every frame due to the distance change of the objects. Therefore the computation power for stitching can be much reduced and the ASIC cost can be saved.

In the following description, the relation between the stitching point and the FOV intersection point alignment is explained.

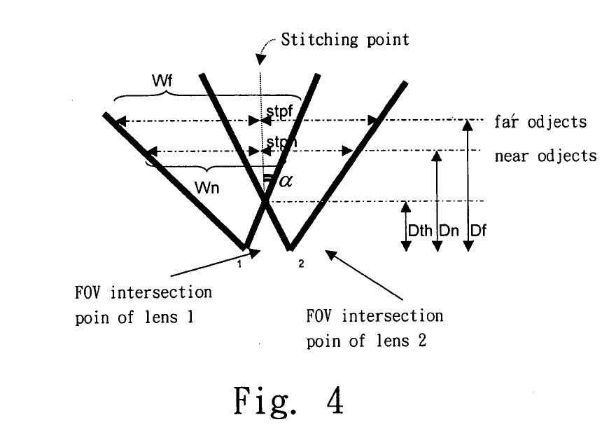

FIG. 3 shows the FOV intersection point of a single lens. FIG. 4 shows the stitching problem caused by the misalignment of FOV intersection points. In the figure, stpn represents the stitching point of near objects; stpf represents the stitching point of far objects; Dn represents the distance between the FOV intersection point and near objects; Df represents the distance between the FOV intersection point and far objects; Dth represents the distance between the FOV intersection point and the FOV cross point; Wn represents viewable width of near objects; Wf represents viewable width of far objects; α represents the angle between overlapped boundary and the stitching point; and HFOV represents horizontal field of view. As shown in FIG. 4, in the case of misalignment, there is no image overlapping for the objects within the distance of Dth. Providing the definition of stitching point is center of the overlapped images, the stitching points shift when the distance between the object and the camera changes.

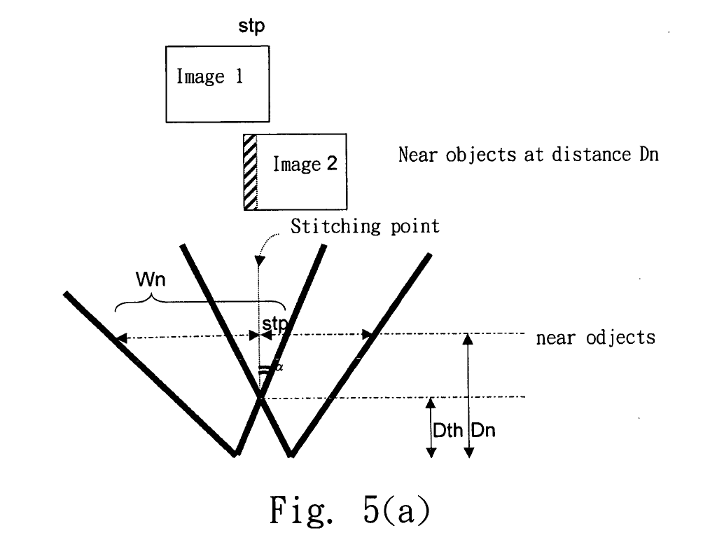

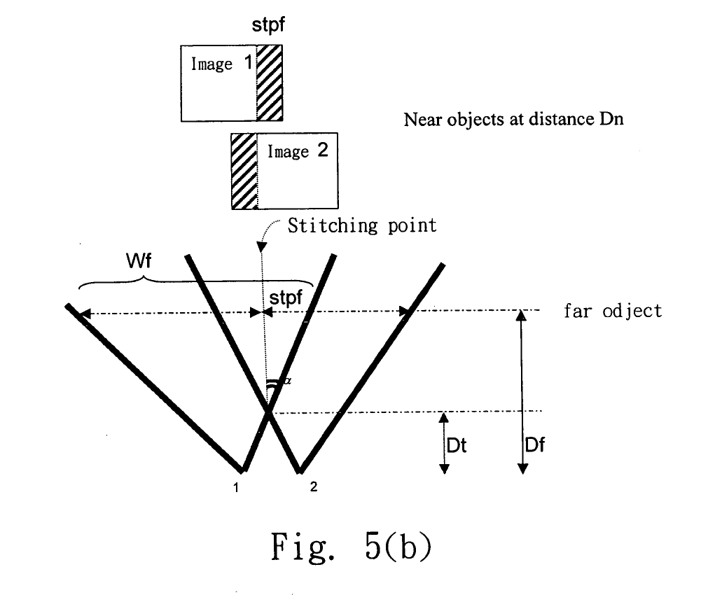

FIG. 5(a) and FIG. 5(b) show overlapping portions of the images of near objects and far objects, respectively, in the case of misalignment. Comparing these two figures, it can be seen that the overlapping portion (shadowed portion) of the images of near objects in FIG. 5(a) is obviously smaller than the overlapping portion (shadowed portion) of the images of far objects in FIG. 5(b).

The stitching point change can be derived from the following equations:

For near objects:

$$stpn = 2 Dn * tan ( \frac{{HFOV}_{i}}{2} ) - ( Dn - Dth ) * tan α$$

$$Wn = 2 Dn * tan ( \frac{{HFOV}_{i}}{2} )$$

The stitching point percentage of near objects within the image is:

$$\frac{stpn}{Wn} = \frac{2 Dn * tan ( \frac{{HFOV}_{i}}{2} ) - ( Dn - Dth ) * tan α}{2 Dn * tan ( \frac{{HFOV}_{i}}{2} )}$$

For far objects:

$$stpf = 2 Df * tan ( \frac{{HFOV}_{i}}{2} ) - ( Df - Dth ) * tan α$$

$$Wf = 2 Df * tan ( \frac{{HFOV}_{i}}{2} )$$

The stitching point percentage of far objects within the image is:

$$\frac{stpf}{Wf} = \frac{2 Df * tan ( \frac{{HFOV}_{i}}{2} ) - ( Df - Dth ) * tan α}{2 Df * tan ( \frac{{HFOV}_{i}}{2} )}$$

Therefore,

$$\frac{stpn}{Wn} \neq \frac{stpf}{Wf} ( since Dth \neq 0 )$$

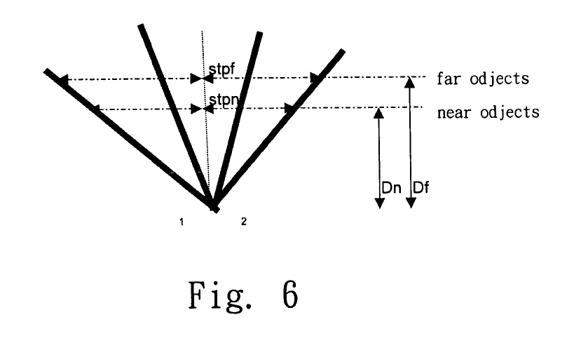

FIG. 6 shows the case in which the FOV intersection points are aligned. In this case, the stitching points remain the same regardless of the object distances. This can be explained by the following equations:

For near objects:

$$stpn = 2 Dn * tan ( \frac{{HFOV}_{i}}{2} ) - Dn * tan α$$

$$Wn = 2 Dn * tan ( \frac{{HFOV}_{i}}{2} )$$

The stitching point percentage of near objects within the image is:

$$\frac{stpn}{Wn} = \frac{2 Dn * tan ( \frac{{HFOV}_{i}}{2} ) - Dn * tan α}{2 Dn * tan ( \frac{{HFOV}_{i}}{2} )} = \frac{2 tan ( \frac{{HFOV}_{i}}{2} ) - tan α}{2 tan ( \frac{{HFOV}_{i}}{2} )}$$

For far objects:

$$stpf = 2 Df * tan ( \frac{{HFOV}_{i}}{2} ) - Df * tan α$$

$$Wf = 2 Df * tan ( \frac{{HFOV}_{i}}{2} )$$

The stitching point percentage of far objects within the image is:

$$\frac{stpf}{Wf} = \frac{2 Df * tan ( \frac{{HFOV}_{i}}{2} ) - Df * tan α}{2 Df * tan ( \frac{{HFOV}_{i}}{2} )} = \frac{2 tan ( \frac{{HFOV}_{i}}{2} ) - tan α}{2 tan ( \frac{{HFOV}_{i}}{2} )}$$

Therefore,

$$\frac{stpn}{Wn} = \frac{stpf}{Wf}$$

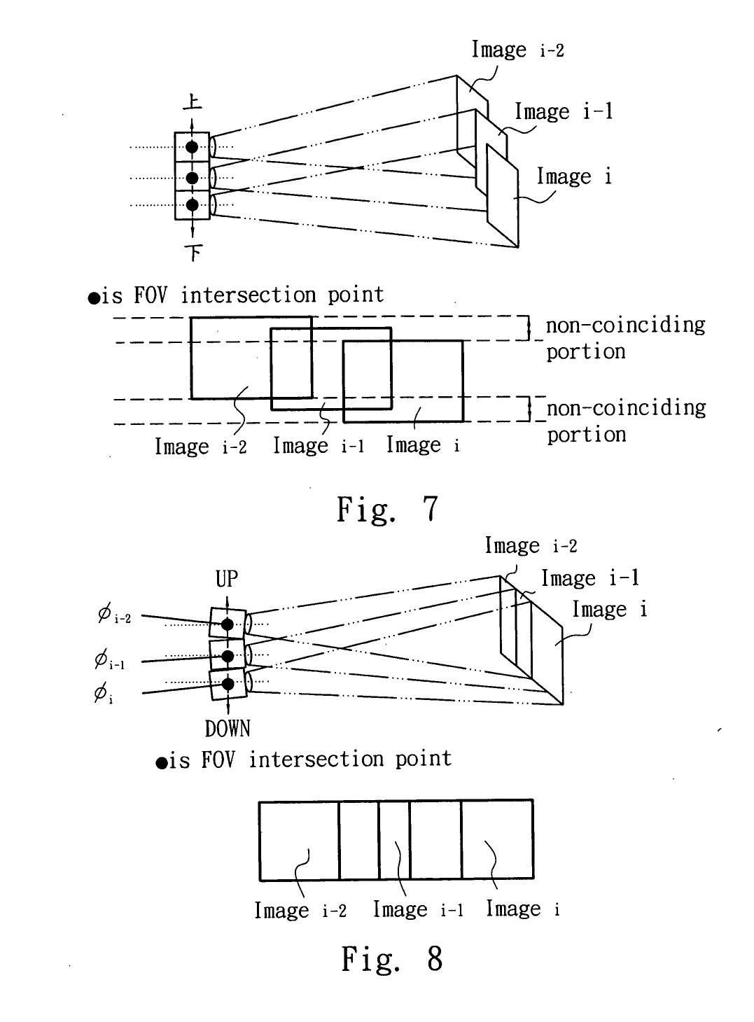

Besides, the images captured by each lens are shifted due to the vertical displacement of FOV FIG. 7 explains the image non-coinciding caused by the FOV displacement. The non-coinciding portions have to be cropped in the final panoramic image. The larger the N is, the more portions are cropped. To solve this problem, the present invention provides positioning means for tilting each lens by φᵢ degrees (0<φᵢ<VFOVᵢ, i=1, 2, . . . , N) in vertical direction. FIG. 8 explains the result obtained by tilting each lens in vertical direction. It should be noted that the FOV intersection points are always aligned while tilting the lenses.

Accordingly, the image pickup device of the present invention is able to provide the images with constant stitching points, thereby simplifying the complexity of the stitching algorithm.

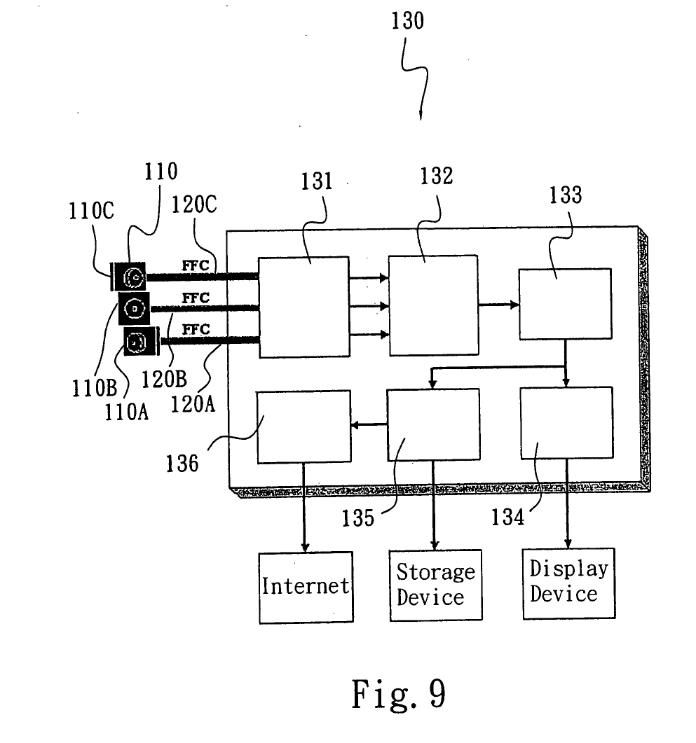

In the following, an embodiment of the multiple lens camera system according to the present invention is described with reference to FIG. 9. For conciseness, the following description is focused on the lens part and the related image processing procedure with the detailed description of other parts of the camera system omitted.

As shown in FIG. 9, a lens part 110 includes three lenses 110A, 110B and 110C, wherein the lens 110B is arranged on top of the lens 110A with a counterclockwise rotation of θ degrees (not shown in the figure) in horizontal direction; and the lens 110C is arranged on top of the lens 110B with a further counterclockwise rotation of θ degrees in horizontal direction. The image signals captured by the lenses 110A, 110B and 110C are passed through FFC (Flexible Flat Cable) 120A, 120B and 120C, respectively, to an image processing logic block 130 for further processing. The image processing logic block 130 includes a multi-lens ISP (image signal processor) 131, stitching logic 132, an ISP 133, a video encoder 134, a MPEG encoder 135 and a network interface 136.

At first, the multi-lens ISP 131 performs preliminary processing of the image signals passed from the lenses 110A, 110B and 110C so that the differences between the images captured by respective lenses are reduced. The image signals after the preliminary processing are respectively passed to the stitching logic 132. The stitching logic 132 performs transformation and positional calculation on the image signals so that the images are put seamlessly together as one single image. Said one single image is then passed to the ISP 133 for traditional image processing. At this point, the processed image can be encoded by the video encoder 134 and then displayed on any display device. Alternatively, the processed image can also be compressed for storing in any storage device. Further, the compressed image data can be passed through the network interface 136 to the Internet.

Effects of the Invention

The stitching algorithm is the part which consumes most computational power when generating a panoramic image. For high frame rate video (e.g. 30 fps), a low-cost ASIC solution is not powerful enough to achieve the performance of updating stitching point for every 1/30 second. The present invention discloses a simple and feasible mechanism for positioning multiple lenses to capture images with constant stitching points, and thus provides a low-cost, small-size and wide-angle camera system.

1. An image pickup device of multiple lens camera system, comprising:
N lenses, wherein the horizontal field of view for each lens is HFOVᵢ (i=1, 2, . . . , N);
positioning means, wherein said positioning means positions each lens on top of the other by rotation of θᵢ degrees, where 0<θᵢ<HFOVᵢ, i=1, 2, . . . , N−1, in horizontal direction, and said positioning means positions each lens so that the FOV intersection points of all lenses are aligned in vertical direction.

2. The image pickup device of claim 1, wherein said positioning means tilts each lens with an angle of φᵢ degrees, where 0<φᵢ<VFOVᵢ, i=1, 2, . . . , N, in vertical direction.

3. The image pickup device of claim 1, wherein θ₁=θ₂=θ₃= . . . θ_{N-1}.

4. The image pickup device of claim 1, wherein the total field of view obtained by said N lenses is equal to
$${\sum }_{i = 1}^{N} {HFOV}_{i} - {\sum }_{i = 1}^{N} ( {HFOV}_{i + 1} - {θ}_{i} ) .$$
